(19) United States
(12) Patent Application Publication
(10) Pub. No.: US 2025/0013661 A1
(43) Pub. Date: Jan. 9, 2025

(54) USING LOGICAL VIEWS FOR LOG-BASED REPLICATION

(71) Applicant: INTERNATIONAL BUSINESS MACHINES CORPORATION, ARMONK, NY (US)

(72) Inventors: Knut Stolze, Hummelshain (DE); Felix Beier, Haigerloch (DE); Luis Eduardo Oliveira Lizardo, BOEBLINGEN (DE); Reinhold Geiselhart, Rottenburg-Ergenzingen (DE)

(21) Appl. No.: 18/460,720

(22) Filed: Sep. 5, 2023

(30) Foreign Application Priority Data
Jul. 3, 2023 (DE) GB2310122.3

(51) Int. Cl. G06F 16/27; G06F 16/22; G06F 16/23

(52) U.S. Cl. CPC G06F 16/27; G06F 16/2282; G06F 16/2393

(57) ABSTRACT

Disclosed herein is a computer implemented method of using a logical view of a base database table of a database system for mirroring or replicating changes in the logical view. The method includes receiving a change request for the logical view; generating a log record for the change request in a transaction log; performing a replication operation to replicate the change request for the logical view in a target database table by inputting the transaction log into a replication tool configured for modifying the target database table using the transaction log.

### BACKGROUND

The present invention relates to database systems.

Database systems typically log changes to a base database table in a log record. A replication tool may read this log record and then propagate these changes to other database tables.

### SUMMARY

In one aspect the invention provides for a computer-implemented method of using a logical view of a database table of a database system for mirroring or replicating changes in the logical view. The method includes receiving a change request for the logical view. The method further includes generating a log record for the change request in a transaction log. The method further includes performing a replication operation to replicate the change request for the logical view in a target database table by inputting the transaction log into a replication tool configured for modifying the target database table using the transaction log.

According to a further aspect of the present invention, the invention provides a computer program product that includes a computer-readable storage medium that has computer-readable program code embodied on it. The computer-readable program code is configured to implement a method according to an embodiment.

According to a further aspect of the present invention, the invention provides a computer system that includes a processor configured for controlling the computer system. The computer system further includes a memory storing machine-executable instructions. Execution of the instructions causes the processor to receive a change request for a logical view of a base database table. Execution of the instructions further causes the processor to generate a log record for the change request in a transaction log of the base database table. Execution of the instructions further causes the processor to perform a replication operation to replicate the change request for the logical view in a target database table by inputting the transaction log into a replication tool configured for modifying the target database table using the transaction log.

### BRIEF DESCRIPTION OF THE DRAWINGS

In the following, embodiments of the invention are explained in greater detail, by way of example only, making reference to the drawings in which:

FIG. 1 illustrates an example of a computing environment;

FIG. 2 shows a further view of the computing environment of FIG. 1; and

FIG. 3 shows a flow chart which illustrates a method of operating the computing environment of FIG. 1 or 2.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Some database systems may implement multi-version concurrency control (MVCC) using views. On a high level, in these examples each row in a table has a single column storing the version number of a row. That version number is used in a so-called query view (logical view) to determine whether the row shall be visible or not. The view contains filtering predicates that ensure only the latest version of each row is visible.

An issue with such database systems is that the query view (logical view) may be based on different base tables. However, transaction logs are currently only written for base database tables. Thus, the query view cannot be used as source for replication tools that read the database system's transaction log. At least not without the replication tool being aware of such a construct and reacting specifically.

In some examples, replication tools can monitor whether the view definition changes. If that happens, it can update its meta data with the information of the new base table. Subsequently, the replication tool will read the transaction log records from that base database table.

The timing of when changes occur may cause problems. It is possible that right after the definition of the query view is changed, data modifications may occur on the logical view, causing transaction log records to be written for the underlying base database table. If the replication tool detects the change of the view definition after such transaction log records were written, it could miss those log records. The data in the replication target could potentially be inconsistent.

Examples may have the advantage that it enables the replication tool to process the log record in the same way it would for a log record for the base database table. This may have the advantage that it provides a means to support views as a source for replication. This may also have the advantage of ensuring that the data in a replication target (the target database table) of the replication tool is consistent with changes in the logical view.

In some examples a logical view of the database may be the result of a stored query of the base database table. In some examples this may be stored in a database dictionary. The logical view may not be part of the physical implementation or storage of the base database table. This may provide several advantages. The logical view may provide for a subset of the data contained within the base database table. This may in some instances provide better security because it does not expose the base database table. A particular user may have permissions to query or look at the logical view but not the base database table. Logical views may also be used to join or simplify multiple tables into a single virtual table. This may also be used to aggregate several different database tables. When the changes to the logical view are stored in the log record, the replication operations can be performed on the base database table or tables, for example, when the logical view is an abstraction or aggregation of multiple database tables. It should be noted that these changes to the logical view may still be replicated, irrespective of the specific definitions of the base database table.

In another example the replication tool is configured for performing a replication operation that replicates changes in the base database table to a different database table using the transaction log. In some examples the target database table may be the different database table.

In another example the target database system is stored or located in a separate system or separate database system from where the logical view of the base database table is located. The replication tool could possibly, in such a case, read the log record of the “base” system, transfer the information read from the log through a network and apply the changes to the “target” system where the target database table is located.

In some examples the transaction log may be a file to which the database system writes. The transaction log may be read by the database system for rolling back a transaction or for recovering from a system failure. The replication tool may be a separate tool from the implementation of the database system, but it may also access directly or indirectly through the database system the files of the transaction log. In some examples the replication tool may be used to identify what changes were applied to the base database table and mirror those changes to some other database or data storage system. In these examples, the functionality of the replication tool may be modified such that changes applied to the logical view are then mirrored to other database tables.

In another example generating a log record for a change request in the transaction log includes logging the change to the logical view as a change to the base database table. This example may be beneficial because it provides a single combined log entry for changes to the logical view and the base database table.

In another example the method further includes storing with each log record of the transaction log for the base database table a set of table IDs that includes a table ID of the base database table and the table ID of the logical view. This example may be beneficial because providing a table ID of the logical view may provide a means of causing the replication tool to function with the transaction log even if the logical view does not have a physical location as a base database table would.

In another example generating a log record for the change request in the transaction log includes writing a view-specific change request log in the transaction log. This example may be beneficial because it provides a view-specific log record.

Database systems may receive an “INSERT INTO <view> . . . ” statement. They may look up the view definition in the catalog/meta-data to derive the formula/algorithm for the view. This may be used to adjust the “INSERT INTO <view> . . . ” statement such that it becomes “INSERT INTO <base-table> . . . ”. When this “INSERT” is executed, the database system may apply the respective data changes to the base table and write corresponding log records for it.

In examples, the same process will still happen. However, the database system will write an additional log record representing the change that is done on the view. The log record will contain the data changes without the (reverse) formula/algorithm of the view being applied.

In another example the log entry in the transaction log includes a physical location identifier. The replication tool is configured to identify a physical location of a source database table using the physical location identifier when performing the replication operation. The physical location identifier could, for example, be a page identifier. Generating a log record for the change request in the transaction log includes writing a virtual location identifier in the log record for the logical view to enable the replication operation of the replication tool without specifying a valid physical location. The replication tool in some examples may read a physical location identifier from a log entry to identify the physical location of a database table. The logical view may however not have a physical location. This example may be beneficial because it may provide a means of enabling the replication tool to use log records originating from change requests to the logical view without recoding the replication tool.

In another example the logical view is one of multiple logical views. This may, for example, include the case where there are multiple independent views defined on the same base database table. This may also include the case where a view can be defined on some other view which is defined on a base database table. This may be beneficial because it may support the aggregation of multiple base database tables as well as views to provide the logical view. When there are complex interdependencies between base tables and views, using the replication tool may provide an effective means of updating the base database table or other logical views when a change to the logical view is made.

A logical view may be a formula or algorithm that describes how to transform the data of the base database table. This could include calculations or combinations of values or combination of multiple tables. It could also include renaming of columns etc.

The formula/algorithm of the logical view may be stored persistently—typically in the catalog/meta-data storage of the database system.

For example, a view could be defined as: “SELECT (column 1+column 2)*0.5 FROM <base-database-table>”. This definition (which is the formula/algorithm) is stored persistently. The data is stored persistently in <base-database-table> only.

Whenever data is modified in a view or queried from the view, the database system may consult the formula/algorithm to determine what exactly has to be done on the base database table on which the view is defined.

In another example the multiple logical views include at least one independent logical view defined on the base database table.

In another example the multiple logical views include at least one dependent logical view defined on the at least one independent logical view.

In another example the method further includes storing a logging flag in the database system implementing the multiple logical views. The database system is configured to enable or disable the logging of the change request for specific logical views of the multiple logical views using the logging flag. This may be useful in the case where there are multiple logical views, and it is not desired to record the log and then use the replication tool to modify the target database table using the transaction log. This may for example provide for more flexibility and data security when using the system. It enables various views to be exposed to users without them having the possibility of modifying the target database table.

In another example the method further includes modifying the logical view using the change request.

In another example the logical view includes a view definition that is descriptive of a data transformation of the base database table. The view definition may essentially be a map or key which enables the construction of the logical view from the base database table. As such, it may be used to translate changes in the change request that could be used to modify the target database table. This also has applicability when the logical view has been created from multiple base database tables or multiple logical views. This may therefore enable changes in the logical view to be propagated into multiple target database tables and multiple logical views.

In another example the logical view is a definition of an access-control list or privileges for an application or computer access. The change request of the logical view is a change request for the access desk control list or privileges. This example may be beneficial because it may provide for a means of updating access-control or privileges to a computer system or application without exposing the original database or files which control this access or privileges.

In another example the logical view joins underlying tables of the base database table to consolidate data records of the base database table.

In another example the replication tool monitors log records written for changes on one or more catalog tables of the base database system to register a change of a view definition. This example may be beneficial because it may provide for a means of automatically updating the base database system when the logical view is modified.

In another example the method further includes, in response to receiving an indication of a change in a definition of the logical view stored in the catalog table of the database system, triggering the writing of one or more log records in the transaction log to indicate that the full content of the logical view has changed. The method further includes the identification of the change in the definition of the logical view by the replication tool by reading one or more log records in the transaction log to indicate that the full content of the logical view has changed. The method further includes replacing data retrieved from the logical view into the target database table using the replication tool.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a database system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

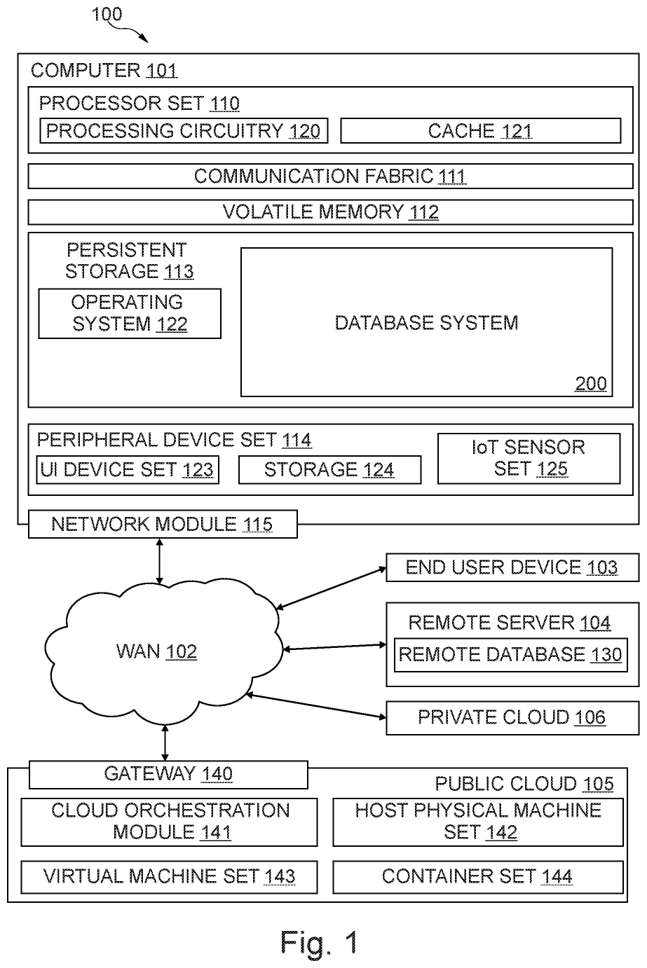

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

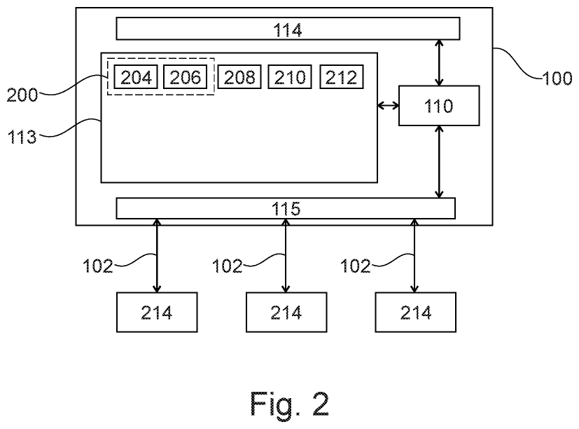

FIG. 2 shows a further view of the computing environment 100. The persistent storage 113 is shown as implementing the database system 200. The database system 200 is shown as including a base database table 206 and a logical view 204. The view 204 is a logical view of the base database table 206.

The persistent storage 113 is further shown as containing a change request 208 that was received from one of the applications 214 that are able to access the database system 200 via the wide area network 102. In response to receiving the change request 208, the transaction log 210 contains a log record that has been generated using the change request 208. The persistent storage 113 is shown as further including an implementation of a replication tool 212. The replication tool 212 is able to perform a replication operation to replicate the change request 208 for the logical view 204 in the base database table 206. In some examples, the replication tool 212 may be part of the database system 200.

In some database systems 200, when a new row is inserted or an existing row is deleted in a base database table 206 of the database system 200, the database system 200 generates a transaction log record and writes that to a file. This is used for multiple purposes. Several significant use cases are:

1. Rollback of a single statement or transaction: If the INSERT or DELETE statement fails, it is necessary to undo any changes this statement may already have done. Since the database system writes a single transaction log record for every row that was inserted/deleted, it is possible to identify quickly all the changes made by the statement or transaction—and to compensate or undo them.

2. Recovery: If the database system crashes, all in-memory content is lost. It may even happen that a media failure occurs and the files in the file system storing all the data are lost. The transaction log can now be used—in combination with a backup image—to restore the tables in the database to any point in time, usually the time right when the crash or media failure occurs. For this, the backup image is used and subsequently the transaction log is processed to apply all changes that were done to all the tables after the backup image was created.

3. Replication: Since the transaction log is a protocol for all changes that happened on a table, it can be used to mirror/replicate all those changes to another table in a different database.

Further, each log record may store or contain one or more of the following information or details:
Table space ID, page ID identifying the page on which the data modification was done.
Table ID identifying the table for which the operation was done.
Operation: Insert vs. Update vs. Delete vs . . . .
Before image of the data being updated or deleted and the after image of the data being inserted or updated
Transaction ID
Various other fields

Examples may use case 3 above (Replication) to process log records generated by a logical view 204.

One feature which may be included in examples is that the database system 200 may write transaction log records not only for data modifications in base database table 206, but it may also write such log records for changes happening on the query view (logical view 204) itself. Further, in examples those log records (from the logical view 204) are handled internally exactly like log records for base tables—in their layout/structure. They may carry an indicator for the special object type.

This may enable the replication tool 212 to process these log records like it does for base tables. But the replication tool can remain agnostic to the fact that it is processing log records for a table. This may have the benefit of gaining additional functionality for the database system without making extensive changes.

Since logical views 204 are logical tables only, there may be no physical pages storing data for the view. Pages for the underlying base database tables exist. Logging happens for base database tables anyway, but those log records contain the ID of the base table—not the view.

Examples may circumvent this limitation by letting each log record for a base table store a set of table IDs. It may not only store the ID of the base database table 206, but additionally the ID of the view. In other words, a log record in the transaction log contains multiple table IDs instead of just one pointing to the based database table 206.

Another approach examples may take is to write separate log records for the logical view 204 and the base database table 206. Thus, each data modification would be logged one time for the logical view 204 and one time for the base database table 206. This approach may be beneficial because it does not require changes to the log record structure, which would imply changes for at least some software components handling log records.

In many database systems 200, each log record contains a table space and page ID identifying the location where the data is stored physically. For views, no such location exists. However, this may have the advantage that it provides a log record solely for the exploitation of replication—not for rollback and/or recovery purposes. Thus, a non-existent physical location could be used instead. For example, table space ID-1 and page ID-1 can be written into the log record.

In some examples, the database system may use the described mechanism for all of its logical views 204.

However, in some examples, it may be more beneficial to selectively handle views such that the logging of changes to a logical view 204 can be enabled or disabled. For this example, the database system 200 could extend its syntax like this:

CREATE OR REPLACE VIEW <view-name>
AS<sub-select>
   LOGGED

The “LOGGED” flag may be stored in the catalog/meta data of the database system 200. Thus, if an INSERT/UPDATE/DELETE occurs on the logical view 204, the database system 200 knows—based on said meta data—that a log record shall be produced.

In another example, one may consider changing the view definition from:
CREATE OR REPLACE VIEW v AS SELECT*FROM <table-1>
to
CREATE OR REPLACE VIEW v AS SELECT*FROM <table-2>WHERE <predicate>

Such a change may cause all the data accessible by the logical view 204 to change instantly. In some examples, the replication tool 212 using that logical view 204 as source may be aware of this.

In another example, the replication tool could monitor log records written for changes on the catalog tables of the database system. But there is another alternative described below.

In some examples, base database tables 206 may be loaded in such a way that logging is bypassed. (This is done to improve performance of the data ingest.) Replication tools 212 may be aware of such non-logged operations so that they can re-populate the target table from scratch by reading the full source table (not just the log records written for the source table). In order to accommodate that, the source database system may write a log record to indicate that such a non-logged LOAD operation happened. (Usually, a single log record is sufficient.)

The same type of procedure can be exploited for changes to the definition of a logged logical view 204. Executing the above CREATE OR REPLACE VIEW causes an update to the meta data in the catalog table, and it may also trigger the writing of a single log record to indicate that the full content of the view has changed. When the replication tool scans the transaction log of the source database system, it may find this log record, and then switches into a mode that discards all data from the replication target table and repopulates the target table with all data retrieved from the view, i.e., the replication source. Once that is completed, the replication tool continues to process the log records that are written for the view.

In some examples, all data modifications are done through the logical view 204. If there were any modifications directly to the base table—without corresponding changes to the view definition, —the described mechanism may potentially not work because no log record for the view would be written.

Examples may provide a way that requires only very minor changes to a database system to support views as source for replication. No complex new functionality is required in the database system or in the replication tool—but a very wide range of possibilities is opened by that. For example, data populated into a backend database (which may use such views) could be replicated to yet another system.

The database systems 200 illustrated in FIGS. 1 and 2 may, for example, be useful when the logical view is a definition of an access-control list or set of privileges. This may provide enhanced security because modifications to the access-control list or set of privileges can be modified within the logical view without providing access to or directly exposing the underlying base database table 206.

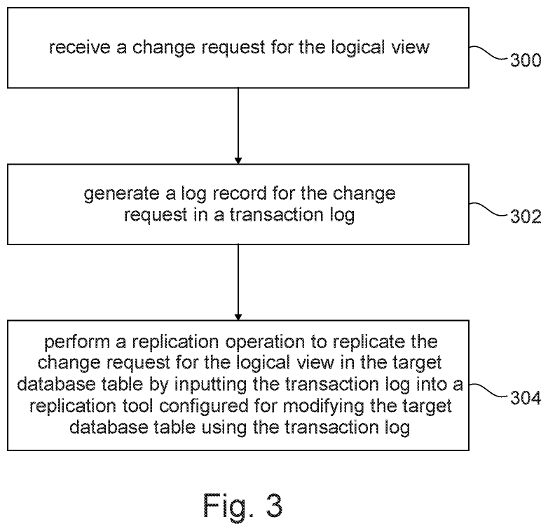

FIG. 3 shows a flowchart which illustrates a method of operating the computing environment 100 illustrated in FIG. 1 or FIG. 2. In step 300 the change request 208 for the logical view 204 is received. In step 302, the log record is generated for the change request 208 in the transaction log 210. In step 304, a replication operation is performed to replicate the change request 208 for the logical view 204 in the base database table 206 or other target database table by inputting the transaction log 210 into the replication tool 212 which is configured for modifying the base database table 206 or other target database table using the transaction log 210.

Various examples may possibly be described by one or more of the following features in the following numbered clauses:

Clause 1. A computer implemented method of using a logical view of a base database table of a database system for mirroring or replication of changes in the logical view, the method including:
receiving a change request for the logical view;
generating a log record for the change request in a transaction log; and
performing a replication operation to replicate the change request for the logical view in a target database table by inputting the transaction log into a replication tool configured for modifying the target database table using the transaction log.

Clause 2. The computer implemented method of clause 1, where the replication tool is configured for performing a replication operation that replicates changes in the logical view to a different database table using the transaction log.

Clause 3. The computer implemented method of clause 2, where the different database table is the target database table.

Clause 4. The computer implemented method of clause 1 or 2, where the target database table is the base database table.

Clause 5. The computer implemented method of any one of clauses 1 through 3, where generating a log record for the change request in a transaction log includes logging the changes in the logical view as changes to the base database table.

Clause 6. The computer implemented method of clause 5, where the method further includes storing with each log record of the transaction log for the base database table a set of table IDs that includes a table ID of the base database table and a table ID of the logical view.

Clause 7. The computer implemented method of any one of the preceding clauses, where generating a log record for the change request in the transaction log includes writing a view specific change request log in the transaction log.

Clause 8. The computer implemented method of clause 7, where the log entry in the transaction log includes a physical location identifier, where the replication tool is configured to identify a physical location of a source database table using the physical location identifier when performing the replication operation, where generating a log record for the change request in the transaction log includes writing a virtual location identifier in the log record for the logical view to enable the replication operation of the replication tool without specifying a valid physical location.

Clause 9. The computer implemented method of any one of the preceding clauses, where the logical view is one of multiple logical views.

Clause 10. The computer implemented method of clause 9, where the multiple logical views includes at least one independent logical view defined on the base database table.

Clause 11. The computer implemented method of clause 10, where the multiple logical views includes at least one dependent logical view defined on the at least one independent logical view.

Clause 12. The computer implemented method of clause 8, 9, or 10, where the method further includes storing a logging flag in the database system implementing the multiple logical views, where the database system is configured to enable or disable logging of the change request for specific logical views of the multiple logical views using the logging flag.

Clause 13. The computer implemented method of any one of the preceding clauses, where the method further includes modifying the logical view using the change request.

Clause 14. The computer implemented method of any one of the preceding clauses, where the logical view includes a view definition that is descriptive of a data transformation of the base database table.

Clause 15. The computer implemented method of any one of the preceding clauses, where logical view is a definition of an access-control list or privileges for an application or computer access, and where the change request of the logical view is a change request for the access-control list or privileges.

Clause 16. The computer implemented method of any one of the preceding clauses, where the logical view joins underlying tables of the base database table to consolidate data records of the base database table.

Clause 17. The computer implemented method of any one of the preceding clauses, where the replication tool monitors log records written for changes on one or more catalogue tables of the database system to register a change of a view definition.

Clause 18. The computer implemented method of any one of the preceding clauses, where the method further includes:
receiving an indication of a change in a definition of the logical view stored in a catalog table of the database system;
in response, triggering the writing of one or more log records in the transaction log to indicate that the full content of the logical view has changed;
identifying the change in the definition of the logical view by the replication tool by reading the one or more log records in the transaction log to indicate that the full content of the logical view has changed; and
replacing data retrieved from the logical view into the target database table using the replication tool.

Clause 19. A computer program product comprising a computer-readable storage medium having computer-readable program code embodied therewith, the computer-readable program code configured to implement the method of any one of clauses 1 to 18.

Clause 20. A computer system including:
a processor configured for controlling the computer system; and
a memory storing machine executable instructions, execution of the instructions causes the processor to:
receive a change request for a logical view of a base database table;
generate a log record for the change request in a transaction log of the base database table; and
performing a replication operation to replicate the change request for the logical view in a target database table by inputting the transaction log into a replication tool configured for modifying the target database table using the transaction log.

What is claimed is:

1. A computer implemented method of using a logical view of a base database table of a database system for mirroring or replicating changes in the logical view, said method comprising:
receiving a change request for the logical view;
generating a log record for the change request in a transaction log; and
performing a replication operation to replicate the change request for the logical view in a target database table by inputting the transaction log into a replication tool configured for modifying the target database table using the transaction log.

2. The computer implemented method of claim 1, wherein the replication tool is configured for performing a replication operation that replicates changes in the logical view to a different database table using the transaction log.

3. The computer implemented method of claim 1, wherein the target database table is the base database table.

4. The computer implemented method of claim 1, wherein generating a log record for the change request in a transaction log comprises logging the changes in the logical view as changes to the base database table.

5. The computer implemented method of claim 4, wherein the method further comprises storing with each log record of the transaction log for the base database table a set of table IDs that comprise a table ID of the base database table and a table ID of the logical view.

6. The computer implemented method of claim 1, wherein generating the log record for the change request in the transaction log comprises writing a view specific change request log in the transaction log.

7. The computer implemented method of claim 6, wherein the log entry in the transaction log comprises a physical location identifier, wherein the replication tool is configured to identify a physical location of a source database table using the physical location identifier when performing the replication operation.

8. The computer implemented method of claim 7, wherein generating the log record for the change request in the transaction log comprises writing a virtual location identifier in the log record for the logical view to enable the replication operation of the replication tool without specifying a valid physical location.

9. The computer implemented method of claim 1, wherein the logical view is one of multiple logical views.

10. The computer implemented method of claim 9, wherein the multiple logical views comprise at least one independent logical view defined on the base database table.

11. The computer implemented method of claim 10, wherein the multiple logical views comprise at least one dependent logical view defined on the at least one independent logical view.

12. The computer implemented method of claim 9, wherein the method further comprises storing a logging flag in the database system implementing the multiple logical views, wherein the database system is configured to enable or disable logging of the change request for specific logical views of the multiple logical views using the logging flag.

13. The computer implemented method of claim 1, wherein the method further comprises modifying the logical view using the change request.

14. The computer implemented method of claim 1, wherein the logical view comprises a view definition that is descriptive of a data transformation of the base database table.

15. The computer implemented method of claim 1, wherein the logical view is a definition of an access-control list or privileges for an application or computer access, and wherein the change request for the logical view is a change request for the access-control list or privileges.

16. The computer implemented method of claim 1, wherein the logical view joins underlying tables of the base database table to consolidate data records of the base database table.

17. The computer implemented method of claim 1, wherein the replication tool monitors log records written for changes on one or more catalogue tables of the database system to register a change of a view definition.

18. The computer implemented method of claim 1, wherein the method further comprises:
receiving an indication of a change in a definition of the logical view stored in a catalog table of the database system;
triggering the writing of one or more log records in the transaction log to indicate that the full content of the logical view has changed;
identifying the change in the definition of the logical view by the replication tool by reading the one or more log records in the transaction log to indicate that the full content of the logical view has changed; and
replacing data retrieved from the logical view into the target database table using the replication tool.

19. A computer program product comprising a computer-readable storage medium having stored thereupon a set of computer-readable program code, said set of computer-readable program code, when executed by a computer, causes the computer to:
receive a change request for the logical view;
generate a log record for the change request in a transaction log; and
perform a replication operation to replicate the change request for the logical view in a target database table by inputting the transaction log into a replication tool configured for modifying the target database table using the transaction log.

20. A computer system comprising:
a processor configured for controlling said computer system; and
a memory storing machine executable instructions, execution of said instructions causes said processor to:
receive a change request for a logical view of a base database table;
generate a log record for the change request in a transaction log of the base database table; and
performing a replication operation to replicate the change request for the logical view in a target database table by inputting the transaction log into a replication tool configured for modifying the target database table using the transaction log.
